(19) United States
(12) Patent Application Publication
(10) Pub. No.: US 2005/0077426 A1
(43) Pub. Date: Apr. 14, 2005

(54) Flotation device for small airplanes

(76) Inventor: Martin Simard, Montreal (CA)

Correspondence Address: INVENTARIUM, SUITE 1607, 4050, ROSEMONT BLVD, MONTREAL, QC, H1X2M4, CA

(21) Appl. No.: 10/961,801

(22) Filed: Oct. 8, 2004

Related U.S. Application Data
(60) Provisional application No. 60/509,180, filed on Oct. 8, 2003.

(51) Int. Cl. B64C 25/54

(52) U.S. Cl. 244/107

(57) ABSTRACT

An emergency flotation device for crashed small airplanes which can be retrofited on most small airplanes as well as come preinstalled on new small airplanes, is self contained in a small container; has several independent triggering means; and has a visual as well as an RF beacon system integrated within to call for rescue.

This application claims priority based on provisional application 60/509,180 filed Oct. 8, 2003

### BACKGROUND OF THE INVENTION

1. Field of the Invention

The invention relates generally to flotation devices but more particularly to an emergency system of deployable bags to help small planes float after an emergency landing on water.

2. Background of the Invention

Bush pilots flying small aircrafts such as cessnas or beechcrafts often fly over wilderness areas with hundreds of lakes. It should come as no surprise that airplane crash landings in lakes occur every now and then. There have been too many situations where passengers and crew have survived the crash but died drowning or through exposure. Once a small plane sinks, it is very difficult if not impossible to find the plane within the short span of time needed to save lives.

A number of inventions relating to flotation devices for airplanes exist, they often comprise a combination parachutes and flotation devices and there is one patent disclosing auxiliary engines as a means of slowing down an otherwise crashing airplane. Other systems are for use on helicopters.

What the prior art does not show is a flotation device that is compact enough to fit on small personal aircrafts and comprises a beacon system that sends a radio signal as well as a visual signal.

### SUMMARY OF THE INVENTION

The present invention discloses an emergency flotation device for crashed small airplanes which can be retrofited on most small airplanes as well as come preinstalled on new small airplanes.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore a main object of this invention to provide for a flotation device which comes self contained in a small container.

It is a second object of this invention to provide for a flotation device which has several independent triggering means.

It is a third object of this invention to provide for a flotation device which has a visual as well as an RF beacon system integrated within.

In order to do so, judiciously positioned air bags are deployed by way of a tank of compressed air; a triggering system; as well as a manual triggering system; and a bag having a beacon attached thereto to provide emergency flotation.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE PREFERRED EMBODIMENT

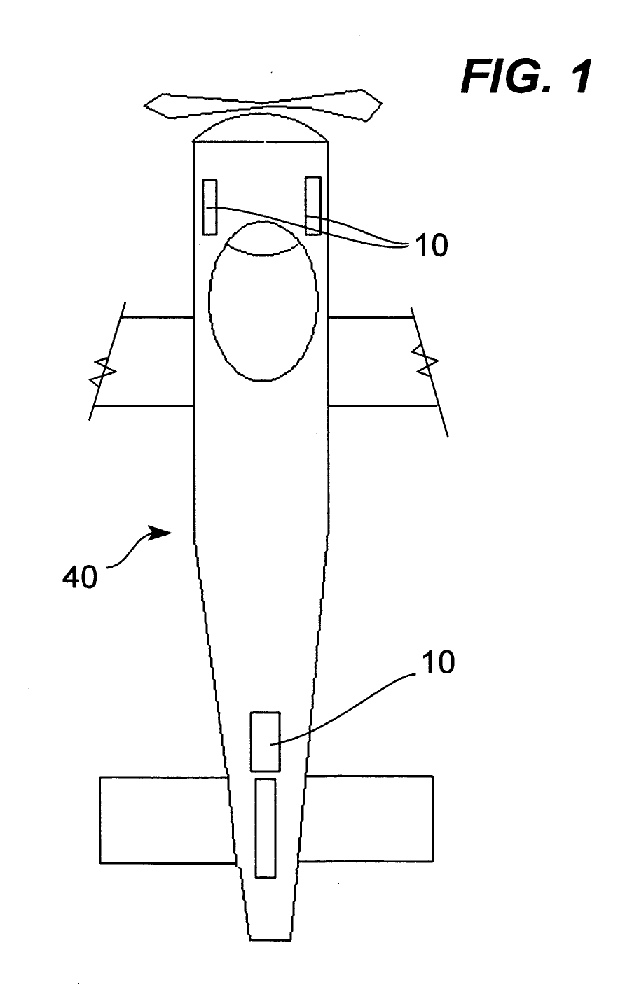

FIG. 1 Top view of a plane indicating the positions of the flotation devices.

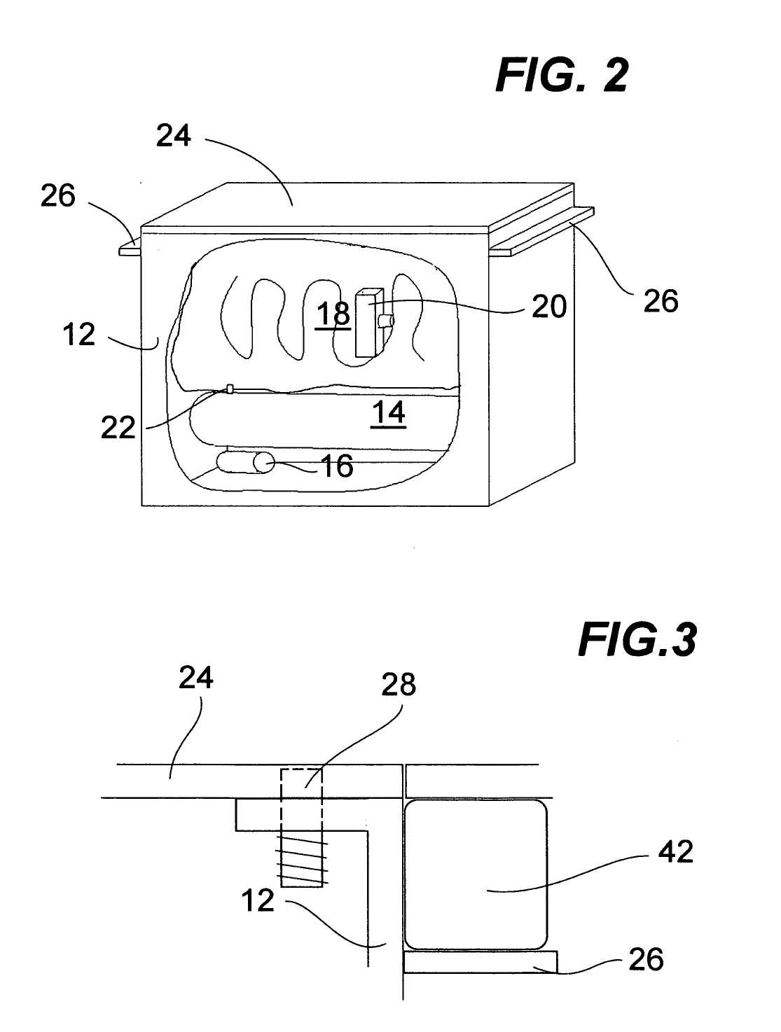

FIG. 2 Perspective view of a flotation device.

FIG. 3 Side view of the release system for the hatch.

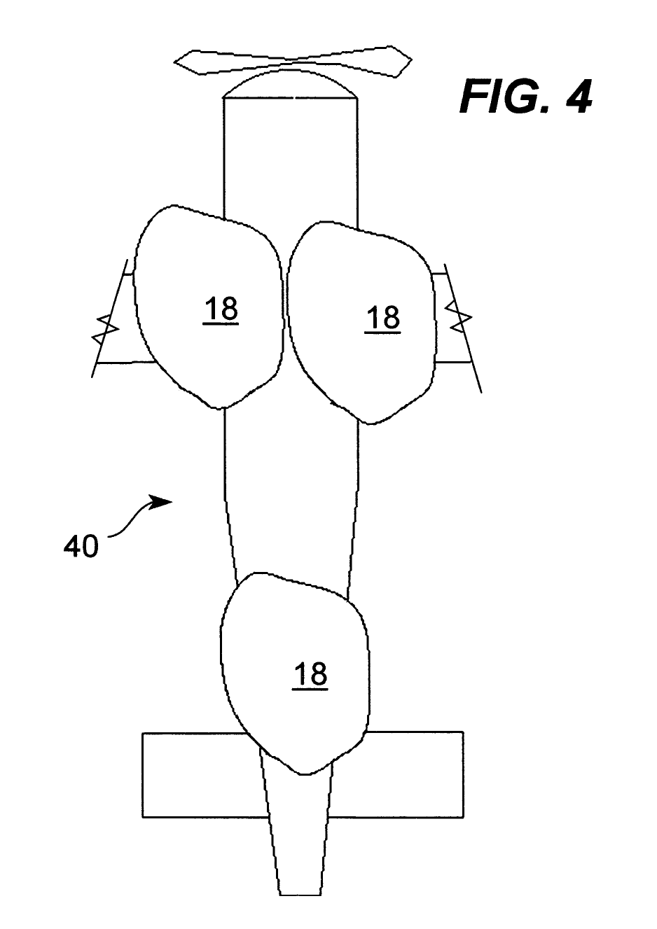

FIG. 4 Bottom view of the plane with the flotation devices deployed.

### DETAILED DESCRIPTION OF THE PREFERRED EMBODIMENT

At least one but preferably a plurality of flotation devices for small airplanes (10) are installed on a plane (40) Each one has a box (12) comprising a tank of compressed air (14); a trigger means (16); and a bag (18) having a beacon (20) attached thereto. The trigger means (16) is a combination of a water detector and G-force detector sensitive to abrupt deceleration much like car air bag systems. A manual triggering system can be used as well, if for any reason the pilot wants extra cushioning just prior to impact or if for one reason or other the bags (18) are not released. When a plane has more than one such box (12), only one needs to contain the beacon (20). The beacon is a combination battery, flashing light and RF distress transmitter which can send a distress signal from the moment it is triggered and even if the bag (18) is not fully deployed, which could occur if some impediment blocks a full release as could happen in a crash.

In use, a crash would activate the trigger means (16) which opens a valve (22) on a compressed air tank (14), the released air inflates the bag (18) which pop opens a hatch (24), thus alowing the bag (18) to fully inflate. The bag (18) is of course made of a sturdy material suitable for the task and which can remain in a compressed folded configuration for an extended period of time and deploy rapidly even if it has been stored for years since it is likely to be unused more often than being used.

The box (12) is mechanically or adhesively or secured to the frame (42) of the airplane (40) by way of brackets (26) or other appropriate securing means selected from current and future developments in securing means, and the hatch (24) is held in place by way of bolts (28) designed to be released such as friction bolts which can only be released by applying a strong pressure coming from the inflating bag (18) or explosive bolts which are triggered by the trigger means (16).

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A flotation device for small airplane comprising:
a box having a tank of compressed air, a trigger means, and a bag having a beacon attached thereto;
said trigger means being, in combination, a water detector, and G-force detector sensitive to abrupt deceleration;
said trigger means opening a valve on a compressed air tank wherein said released air inflates said bag and said inflating bag opening a hatch to allow for full inflation of said bag.

2. A flotation device for small airplane as in claim 1 wherein:
said hatch being held in place by way of bolts designed to be released so as to allow expansion of said bag.

3. A flotation device for small airplane as in claim 1 wherein:
said beacon being a combination battery, flashing light and RF distress transmitter sending a distress signal.

4. A flotation device for small airplane as in claim 1 wherein:
said box being secured to a plane's frame by securing means.

5. A flotation device for small airplane comprising:
a box having a tank of compressed air, a trigger means, and a bag having a beacon attached thereto;
said trigger means being, in combination, a water detector, and G-force detector sensitive to abrupt deceleration;
said trigger means opening a valve on a compressed air tank wherein said released air inflates said bag and said inflating bag opening a hatch to allow for full inflation of said bag;
said hatch being held in place by way of bolts designed to be released so as to allow expansion of said bag;
said beacon being a combination battery, flashing light and RF distress transmitter sending a distress signal;
said box being secured to a plane's frame by securing means.

6. A flotation device for small airplane as in claim 5 wherein:
said securing means being selected from the group comprising mechanical fastening means.

7. A flotation device for small airplane as in claim 5 wherein:
said securing means being selected from the group comprising adhesive fastening means.

8. A flotation device for small airplane as in claim 5 wherein:
said bolts being friction bolts releasable by applying a strong pressure coming from said inflating bag.

9. A flotation device for small airplane as in claim 5 wherein:
said bolts being explosive bolts triggered by said trigger means.

10. A flotation device for small airplane as in claim 5 wherein:
said securing means being selected from the group comprising mechanical fastening means;
said bolts being friction bolts releasable by applying a strong pressure coming from said inflating bag.

11. A flotation device for small airplane as in claim 5 wherein:
said securing means being selected from the group comprising adhesive fastening means.
said bolts being explosive bolts triggered by said trigger means.

12. A flotation device for small airplane as in claim 5 wherein:
said securing means being selected from the group comprising adhesive fastening means.
said bolts being friction bolts releasable by applying a strong pressure coming from said inflating bag.

13. A flotation device for small airplane as in claim 5 wherein:
said securing means being selected from the group comprising mechanical fastening means;
said bolts being explosive bolts triggered by said trigger means.

14. A flotation device for small airplane as in claims 1 and 5 wherein:
a manual triggering system can be used to trigger deployment of said bag.

15. A flotation device for small airplane as in any of claims 10-13 wherein:
a manual triggering system can be used to trigger deployment of said bag.
